(19) United States
(12) Patent Application Publication
(10) Pub. No.: US 2009/0082014 A1
(43) Pub. Date: Mar. 26, 2009

(54) SYSTEM FOR EXTENDED ROAMING MESSAGES

(75) Inventors: Ed Kryszkiewicz, Elk GroveVillage, IL (US); Shalini Agrawal, Schaumburg, IL (US); Sumeet Paul, Chicago, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: SMITH MICRO SOFTWARE, INC., Aliso Viejo, CA (US)

(21) Appl. No.: 12/234,142

(22) Filed: Sep. 19, 2008

Related U.S. Application Data
(60) Provisional application No. 60/974,290, filed on Sep. 21, 2007.

(51) Int. Cl. H04Q 7/20

(52) U.S. Cl. 455/432.1

(57) ABSTRACT

A method and apparatus are provided for the display of extended roaming messages to a user of a WWAN device. The method includes the steps of retrieving a list of one or more available wireless networks, loading a roaming rule list which contains an ordered list of records, matching each of the available networks against said roaming rule list, selecting a roaming message for at least one match and, and displaying at least one roaming message to the end user.

### CROSS REFERENCE TO RELATED APPLICATIONS

The present application claims the benefit of the filing date of U.S. Provisional Patent Application, Ser. No. 60/974,290, filed Sep. 21. 2007, bearing the title, “SYSTEM FOR EXTENDED ROAMING MESSAGES CATEGORIZED BY END USER COSTS” and incorporated herein by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to wireless wide area networking (“WWAN”) data communications. More particularly the present invention relates to a system and method for providing the user of WWAN services with a display of the different networks available to them at any particular location. More specifically, the method relates to a method to being able to present information about each of the available wireless networks such as expected quality of service, availability and connection costs.

### BACKGROUND INFORMATION AND DISCUSSION OF RELATED ART

Wireless Wide Area Networking (“WWAN”) is governed by an evolving set of standards that allow users to get connected in an ever increasing number of points on the globe. CDMA and GSM are examples of WWAN standards. These standards allow devices to roam from one network to another which allows a user to gain access to wireless services outside of their home network. While WWAN standards facilitate roaming between networks and allow Mobile Network Operators (“MNOs”) the flexibility to control the roaming of their users, they generally lack features that allow users to be able to understand the ramifications and costs of wireless roaming.

### BRIEF SUMMARY OF THE INVENTION

There is a need, from a user's perspective, to know about roaming charges prior to connecting and using a network. Current solutions will only tell a user if a certain network is allowed (“Allowed Roaming Network”) by their MNO or is disallowed (“Blocked Roaming Network”). Allowed Roaming Networks are generally facilitated through roaming agreements between MNOs. It would be advantageous, therefore, to present messaging to the user to explain the costs involved in using a particular Allowed Roaming Network. Moreover, it is desirable that the user can then choose the best network depending on their needs, for example wanting a lower cost wireless connection or needing a higher performance link.

Under illustrated embodiment, the invention allows for enterprise customers to be able to create policies for their mobile workers. These policies would in effect create an enterprise specific Allowed Roaming Network (“Enterprise Roaming Network”) and customized Blocked Roaming Network (“Enterprise Blocked Network”). These policies can help enterprises control costs of their roaming users.

Illustrated embodiments of the present invention provide a system and method of information display regarding WWAN service levels and costs. When GSM or CDMA data devices are roaming, there is a need to be able to present messaging appropriate to the end user about available networks, which include costs associated with using that network.

When presenting networks, each network's Mobile Country Code (“MCC”), Mobile Network Code (“MNC”) and Location Area Code (“LAC”) is used to group networks into a number of subgroups. By filtering network entries by MCC, MNC and LAC the end user is provided with the appropriate roaming message.

An lookup table of criteria is used to evaluate networks. At each entry in the table, the entry is compared against the currently evaluated network's information. Each entry is capable of containing exact values or a range of values (MCC 1 through 10), or any combination of ranges. Once a match is made, the appropriate prompt is loaded and displayed to the user. There is also a “final” entry which can be used to disallow access to specific networks. This is useful in the case where any network not explicitly listed SHOULD be allowed to access, but a handful (or large) group of networks should be DISALLOWED.

By doing this at the application level, a user has the ability to integrate information fetched from the backend servers (through HTTP or other mechanisms) which can be used to update the messaging with specific details about the individual's account.

The system and method, when applied to a WWAN device, employs the following method steps:
(a) The list of available networks is fetched from the WWAN device and stored in an “Available Network List”.
   a. For each network, the MCC, MNC is retrieved
   b. If the WWAN device supports it, the LAC is also retrieved for each network
(b) The “Roaming Rule List” is retrieved from the device's storage
   a. The list can be pre-sorted by MCC, MNC and LAC, or
   b. The list is sorted after it is loaded from device storage
(c) For each network in the Available Network List, it is matched against the Roaming Rule List.
(d) A match results in either denoting the connection as “Allowed” or “Disallowed”
(e) A list of Allowed networks is presented to the user with the prompt displayed next to the network name
   a. This list can be sorted by the user by cost, Quality of Service (“QOS”) or other attribute available in the Roaming Rule List.
(f) The user selects the best network that suits their needs.
(g) The WWAN device is instructed to connect to the user selected network

In the case of a new wireless network becoming available, it should be noted that the system and method for presenting extended roaming messages can be used even if the user is already connected to another wireless network. This ability to display end user messages to the user regardless of whether the device being connected to a WWAN network or not is novel and unrelated to the way in which the situation is handled by WWAN devices today, and achieves far better results.

It is therefore an object of the present invention to provide a new and improved system and method to display messages to the end user to explain the cost to use particular WWAN networks.

It is another object of the present invention to provide a new and improved method of sorting available networks by cost. This sorting will allow the cheapest networks to be easily displayed and selected by the user.

It is another object of the present invention to provide a new and improved method of detecting and displaying quality of service by each available WWAN network. This allows a user to sort the Available Network List by performance and easily choose the highest performing network.

Yet another object of the method is to provide a method to allow enterprise IT administrators to control access to a certain set of WWAN networks. This allows the admin to easily control costs, in the cases that certain WWAN networks are more costly to access in various countries.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 depicts a WWAN device in accordance with an illustrated embodiment of the invention;

FIG. 2 is a schematic flow diagram illustrating the general functional elements of the Roaming Rule List used by the system of FIG. 1; and

FIG. 3 depicts a display that may be shown on the display of FIG. 1.

### DETAILED DESCRIPTION OF THE INVENTION

Definitions: As used herein, the term “Roaming Rule List” means a collection of records that contain, at a minimum a set of matching rules for one or more of the following elements:
Mobile County Code (“MCC”)
Mobile Network Code (“MNC”)
Location Area Code (“LAC”)

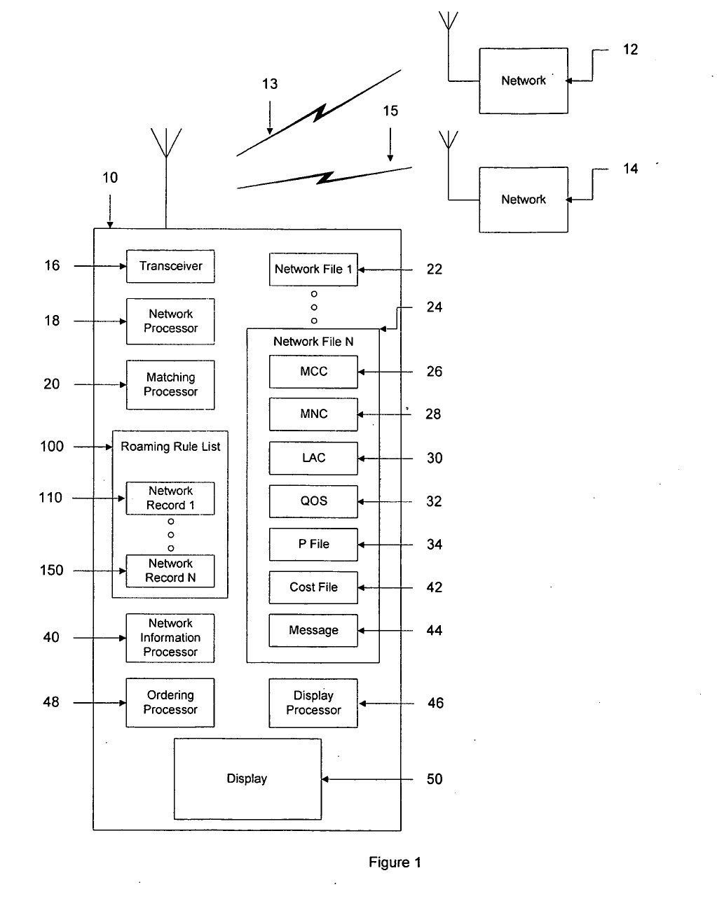

FIG. 1 is a portable WWAN device (e.g., a cell phone, a PDA, a laptop computer, etc.) 10 shown generally in accordance with an illustrated embodiment of the invention. During use, a transceiver 16 within the WWAN device 10 may monitor and detect service provider networks (service providers) 12, 14.

Upon detecting a network 12, 14, a network processor 18 may determine a quality of service (QOS) of a transmission 13, 15 from each network 12, 14. The network processor 18 may also decode messages from the providers 12, 14 to determine a MCC, a MNC and LAC number, if available. Upon determining the MCC, MNC and LAC numbers of each network 12, 14, the network processor 18 may open a respective network file 22, 24 for each network 12, 14. Within the file 22, 24, the network processor 18 may save the MCC number 26, the MNC number 28, the LAC number 30 and the QOS 32.

As used herein “Entry Definitions” means a matching rule that exists in each Record of the Roaming Rule List. Entry Definitions can contain one or all of the following match Criteria:
Exact Match: Denoted by a Digit (0-9)—“9” matches “9” but “9” does not match other digits
Single Wildcard Character: Noted by a ‘?’—“2?” matches “21” or “22” but does not match “12”
Multiple Wildcard: Denoted by a asterisk (*)—“2*” matches “21” or “212” or “2123” but does not match “3” or “42”.

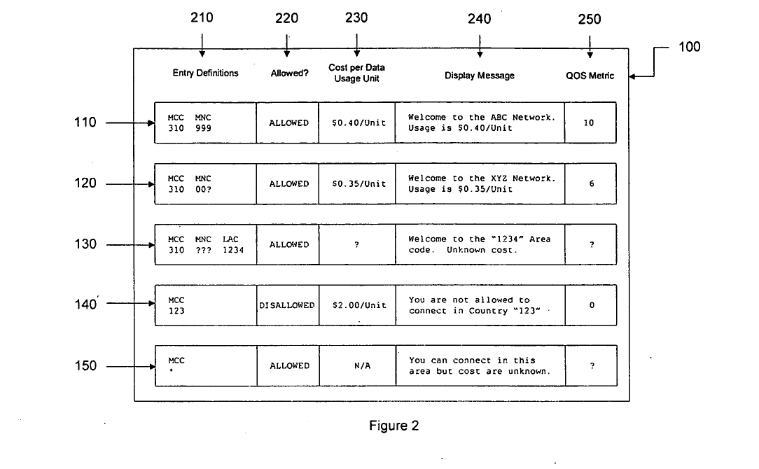

Referring to FIG. 2, there is illustrated therein a specific embodiment of a new and improved system and method for generating and displaying extended roaming messages, generally denominated 100 herein is the Roaming Rule List.

Referring now to FIGS. 1 and 2, showing a Roaming Rule List file 100 which contains one or more Entry Definition files (110 through 150) that defines a use parameter for each network 12, 14. The Entry Definitions shown contain various definitions for MCC, MNC and LAC. Entry 110 shows an Entry Definitions with a MCC and MNC which specifies a specific network on any LAC. Entry 120 defines a range of networks by using a ‘?’ wildcard character in its definition. Entry 130 shows how the LAC can be optionally used to create a match for a specific LAC on multiple networks. Entry 140 shows use of only the MCC which would match an MNC within the defined MCC. Lastly, Entry 150 shows a default match entry which will match assuming no other matches are found in the Roaming Rule List.

In effect, entries (i.e., files 110, 120, 130, 140, 150) contain a respective classifications for each network 12, 14. The network processor 18 receives the MCC number, the MNC number and the LAC number from each network 12, 14. The MCC, MNC and LAC numbers may be transferred to a matching processor 20 that then classifies the networks by matching the MCC, MNC and LAC with one or more of the Entry Definitions of the list 100. The classification of each network 12, 14 may be saved in a permissions file 34 of the respective network 12, 14. The classification may be according to whether the user is allowed or not allowed to access the network 12, 14.

Included within the files 110 to 150 (FIG. 1) may be a name of each system 12, 14, the costs of using the respective networks 12, 14 and a display message.

Once each network 12, 14 has been classified, a network information processor 40 may use the MCC number 26, the MNC number 28 and the LAC number 30 to retrieve use information from the files 110 to 150. The network information processor 40 may save the cost of use of each network 12, 14 in a cost file 42 for each network 12, 14 and the display message in a display message file 44.

An ordering processor 48 may retrieve the files 22, 24 and order the networks 12, 14 based upon any appropriate use parameter (e.g., cost, QOS, etc.). Once ordered, the ordering processor 48 may be transfer an ordered list of files 22, 24 to a display processor 46.

The display processor 46 may retrieve the files 22, 24 and display the use parameters of each network 12, 14 on a display screen 50 of the device 10 for the benefit of the user.

Each row of FIG. 2 shows information for a respective network 12, 14 that is, in turn, shown on the display 50. The column of data 210 defines the Entry Definitions detailed above. Columns 220-250 show specific data that can be stored in the Roaming Rule List for each Entry Definition. Column 220 denotes if the user is allowed to connect to this network from the permissions file 34. Records that match and have the value of ALLOWED will let the user connect to the network while records with values of DISALLOWED will not let the user connect to networks matching this record. Column 230 denotes a cost for usage of networks retrieved from network information files 10 to 150 and saved in the network display files 22, 24. Records can contain a cost value or not. Cost values can be expressed in units such as time (hours, minutes or seconds), or amount of data (bytes, kilobytes, megabytes etc). The Display Message column 240 holds a message 44 to be displayed to the end user. This message can be of any length and expresses a meaningful message to the user explaining network quality, costs, or can explain that the user is not allowed to connect to a specific network. Column 250 shows a field that holds a Quality of Service metric 32. These values can be used to display the quality of service to the user or in order to sort the list of networks for the user.

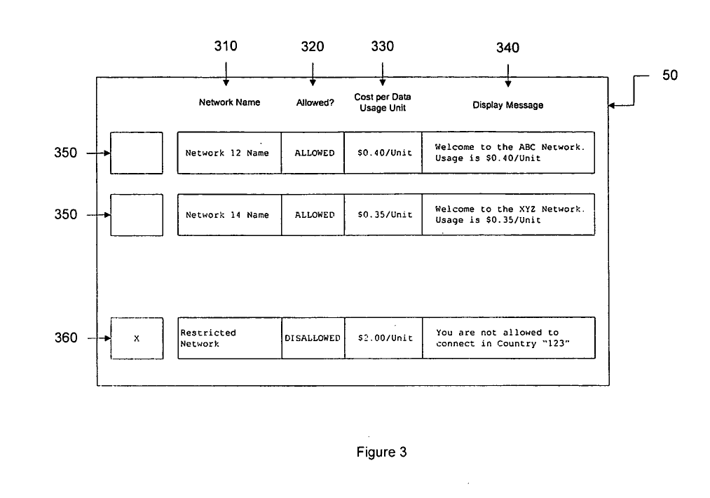

FIG. 3 shows a screen that may be shown on the display 50 in response to application of the Roaming List file 100 to detected networks 12, 14. The user may review the information on the screen of FIG. 3 and select a network 12, 14 based upon any appropriate use parameter. The user may activate an associated softkey 350 to select an appropriate network 12, 14. The associated softkey 360 of disallowed networks is disabled.

The Roaming Rule List 100 and network information files 110 to 150 may be periodically updated through a connection with a selected network 12, 14. Alternatively, the files may be initialized or updated through an Internet http or https connection through a host computer.

A specific embodiment of method and apparatus for displaying extended roaming information has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

What is claimed is:

1. A method for the display of extended roaming messages to a user of a WWAN device comprising:
retrieving a list of one or more available wireless networks;
loading a roaming rule list which contains an ordered list of records;
matching each of the available networks against said roaming rule list;
selecting a roaming message for at least one match and; and
displaying at least one roaming message to the end user.

2. The method of claim 1, further including the step of allowing both a full or partial match of the wireless network against each record of the roaming rule list

3. The method of claim 1, further including using the MCC and MNC from each available network to perform the match against the roaming rule list

4. The method of claim 1, wherein the LAC from each available network is used to perform the match against the roaming rule list

5. The method of claim 1, further including the step of updating the roaming rule list on the device over a network.

6. The method of claim 5, wherein the roaming rule is downloaded via HTTP or HTTPS.

7. A method of displaying extending roaming messages to a user of a WWAN device comprising:
detecting a plurality of WWAN service providers;
determining a use parameter for each provider of the plurality of service providers;
ordering the plurality of WWAN service providers into a list based upon the use parameter; and
displaying the ordered list to the user.

8. The method as in claim 7 wherein the use parameter further comprises cost.

9. The method as in claim 7 wherein the use parameter further comprises quality of service.

10. The method as in claim 7 wherein the use parameter further comprises a rule regarding use of a WWAN service provider of the plurality of WWAN service providers.

11. The method as in claim 7 wherein the use parameter further comprises an identifier of at least one of the group consisting of mobile country code, mobile network code and location area code.

12. The method as in claim 11 wherein the identifier further comprises a wildcard.

13. A portable WWAN device displaying extending roaming messages to a user of a WWAN device comprising:
a transceiver that detects a plurality of WWAN service providers;
a use parameter that is determined for each provider of the plurality of service providers detected by the transceiver;
an ordering processor that orders the plurality of WWAN service providers into a list based upon the use parameter; and
a display that displays the ordered list to the user.

14. The portable WWAN device as in claim 13 wherein the use parameter further comprises cost.

15. The portable WWAN device as in claim 13 wherein the use parameter further comprises quality of service.

16. The portable WWAN device as in claim 13 wherein the use parameter further comprises a rule regarding use of a WWAN service provider of the plurality of WWAN service providers.

17. The portable WWAN device as in claim 13 wherein the use parameter further comprises an identifier of at least one of the group consisting of mobile country code, mobile network code and location area code.

18. The portable WWAN device as in claim 17 wherein the identifier further comprises a wildcard.

19. The portable WWAN device as in claim 17 wherein the display further comprises an indicator of whether each of the plurality of service providers are allowed or disallowed.

20. The portable WWAN device as in claim 17 wherein the display further comprises a displayed cost of each of the plurality of service providers.
